(19) United States
(12) Patent Application Publication
(10) Pub. No.: US 2011/0219682 A1
(43) Pub. Date: Sep. 15, 2011

(54) Plant protector cage

(76) Inventor: Allan P. Butler, Petaluma, CA (US)

(21) Appl. No.: 12/661,186

(22) Filed: Mar. 12, 2010

(51) Int. Cl. A01G 13/10

(52) U.S. Cl. 47/31

(57) ABSTRACT

A plant protector cage with a rectangular portion of wire cloth screen and a circular portion of wire cloth screen. The perimeter of the circular portion is trimmed in a metal band. The rectangular portion is wrapped into a cylindrical shape which is then formed into a pleated, open bottomed conical shape. The perimeter of the circular portion is fixedly attached to the bottom conical shape. A preferred embodiment includes an above ground collar that is fixed to the top rim of the conical cage and tapers upwardly and inwardly to a central plant receiving aperture. A preferred embodiment includes the ground collar is molded in two halves of UV resistant rigid plastic.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of plant protecting devices and more specifically to a plant and root protector cage.

The destruction of roots of plants by underground rodents such as gophers and moles is well known. Numerous designs have been proposed and sold to help solve this problem including electric shock probes, water flooding, pest killing food and root cages. One root cage can be seen in U.S. Pat. No. 6,067,752. It consists of a wire mesh screen wrapped into a cylinder. A hole is dug into the ground. The cage is set in. The hole is then filled with dirt and the roots of a plant are inserted into the dirt. The mesh is supposed to prevent underground animals from chewing on the roots of the plant. However, there is a deficiency in the prior designs in that they are not tapered so they can not nest into each other for compact storage and shipping. Additionally, current cage designs are open on the bottom thereby allowing animals to enter the cage from the bottom. Finally, they do not include top collars that can prevent above ground animals from accessing the plant body.

### BRIEF SUMMARY OF THE INVENTION

The primary object of the invention is to provide a protective cage for plant roots that prevents subterranean dwelling rodents, such as gophers and moles, from accessing and consuming the life supporting root growth system of a typical seedling, sapling, garden plant, bush or tree.

Another object of the invention is to provide a protective cage for plant roots that is tapered for compact stacking.

Another object of the invention is to provide a protective cage for plant roots that includes a wire mesh bottom portion to prevent access to roots while allowing air and water flow.

A further object of the invention is to provide a protective cage for plant roots that is economically constructed of pleated wire mesh.

Yet another object of the invention is to provide a unique bending and pleating fixture to pleat the wire mesh to the desired tapered cage construction.

Still yet another object of the invention is to provide a collar that attaches to the top lip of the cage to help prevent above ground animals from eating plant stems or foliage.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a plant protector cage comprising: a rectangular portion of cloth mesh screen, a circular portion of wire doth screen, the perimeter of said circular portion trimmed in a metal perimeter band, said rectangular portion wrapped into a cylindrical shape, said cylindrical shape formed into a pleated, conical shape, and the perimeter of said circular bottom portion fixedly attached to the lower edge of said conical shape. A plastic molded collar is affixed to the top edge of the conical wire cloth screen.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is an exploded view of the invention.

FIG. 3 is a perspective view of the cylindrical shape at the start of construction.

FIG. 4 is a top plan view of the cylinder as it is being bent into pleats.

FIG. 5 is a top plan view of the bottom portion.

FIG. 6 is a bottom perspective view of the invention.

FIG. 7 is a side section view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

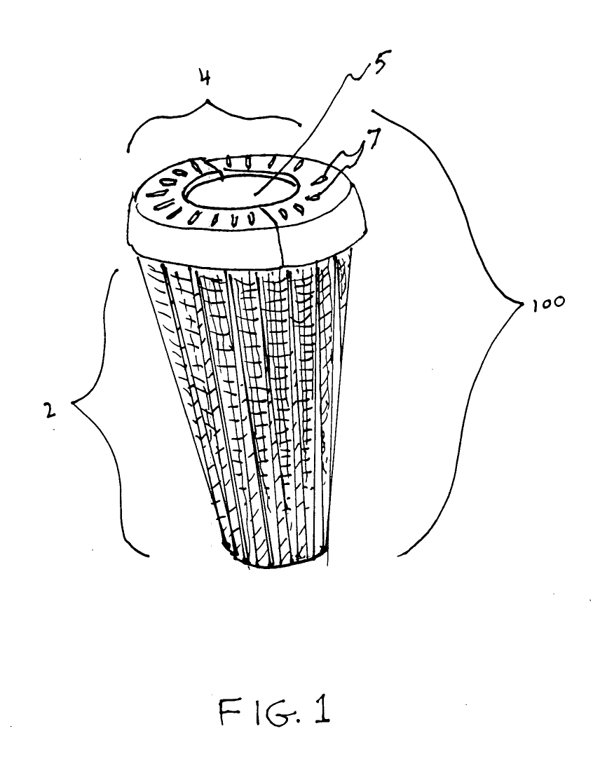

Referring now to FIG. 1 we see a perspective view of the present invention 100. A wire form cage 2 is tapered in shape and topped by a collar portion 4 forming an aperture 5. Radial apertures 7 in the top of the collar 4 allow rain to pass through to the ground underneath the collar. The wire cage 2 is made of commercially available nineteen gauge galvanized wire doth, otherwise known as hardware cloth. The wire cloth has half inch square spacing throughout the body of the cloth. Although this spacing can be smaller or larger depending on the overall size of the cage 2 and plant that it is meant to protect. The collar 2 is molded of UV resistant rigid plastic such as high density polypropylene.

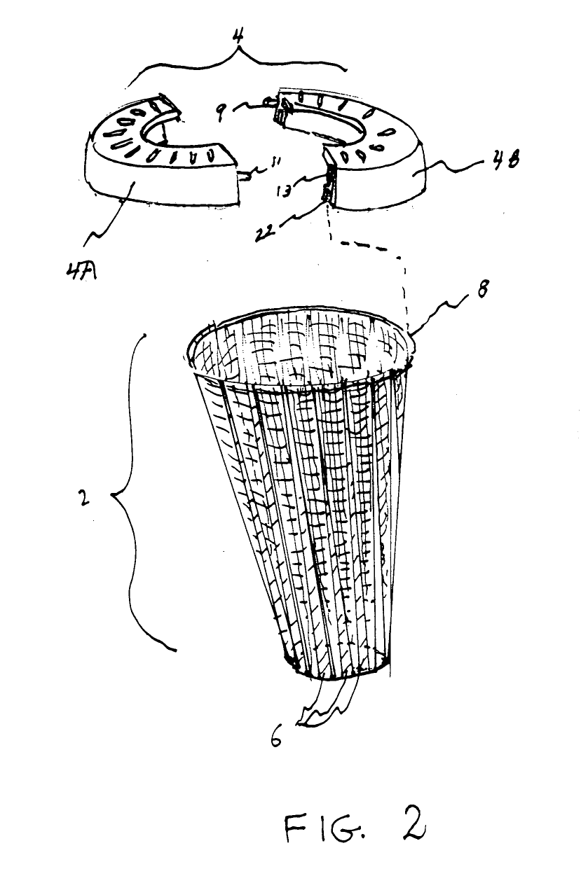

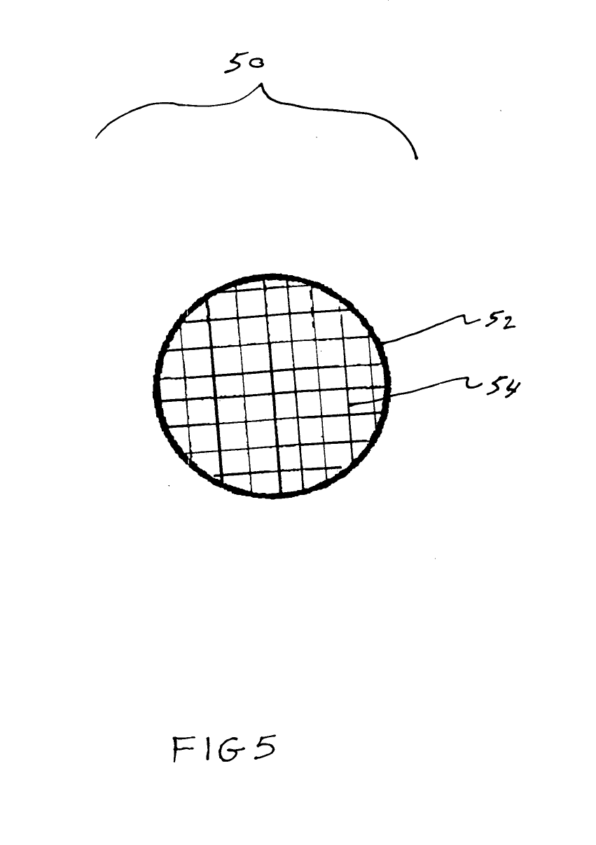

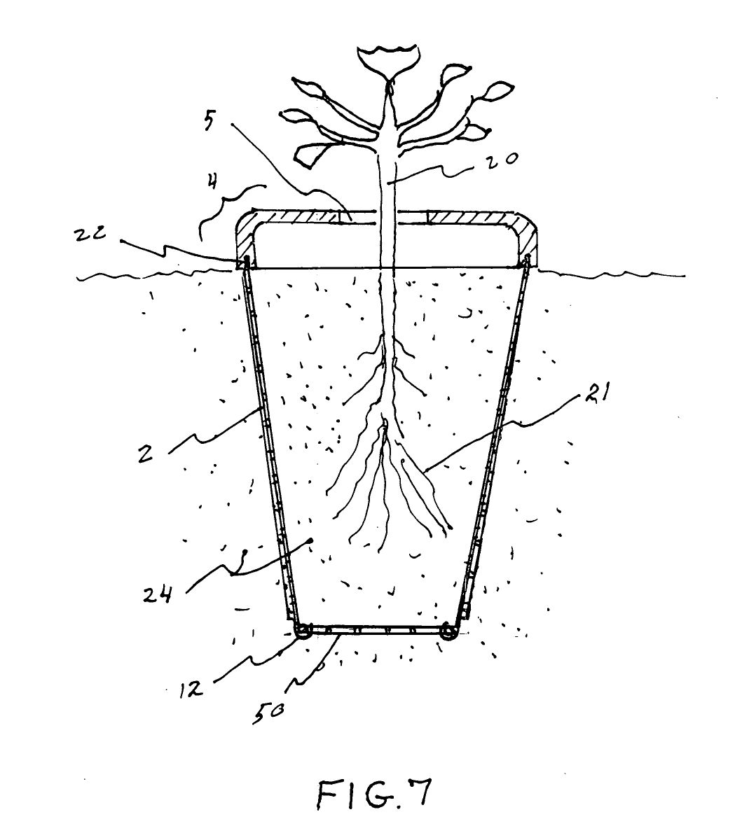

FIG. 2 shows an exploded view where the collar 4 is shown split in two halves 4A and 4B. The halves are connected to each other by posts 9, 11 and mating aperture 13 and a similar aperture in part 4A not shown. However, other standard means of connection may be used. The collar 4 is then installed onto the top lip 8 of tapered cage 2 via recessed radial slot 22. An additional view of the assembly can be seen in FIG. 7 which shows a bisected section view of the invention 100 in use as a root and plant 20 protector. The cage 2 includes a bottom portion 50 that is held in place by wrapping the bottom pieces 12 of the wire cloth around the rim 52 of the bottom piece 50. The bottom piece 50 can be seen clearly as a top plan view in FIG. 5 where the wire cloth disk 54 is trimmed by a metal bead rim 52. The collar 4 can be removed or replaced as necessary. Because of its two piece construction, the collar 4 may be removed or replaced without disturbing the plant 20 growing within the collar 4.

Referring back to FIG. 7, the cage portion 2 of the present invention 100 is inserted into a hole dug into the earth 24. The hole is then filled back with dirt 24 and the cage 2 is topped with collar 4. The cage 2 prevents underground rodents such as gophers and moles from getting at the roots 21 either from the side or from below. The collar 4 prevents subterraneous animals from climbing over and into the top of cage 2 and also prevents above ground animals such as slugs and snails from eating the above ground portions of plant 20.

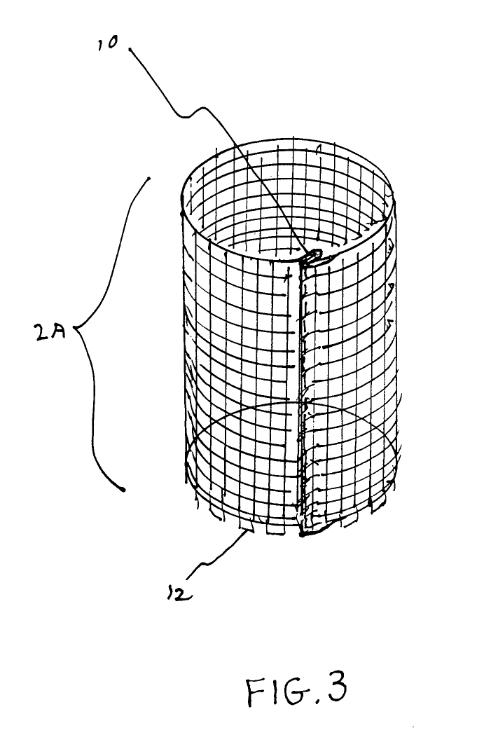

FIG. 3 shows a perspective view of the wire cloth cage in its first stages of construction. The wire cloth has been stamped out to a precise size to provide the necessary beginning pattern required for construction of the cage 2. The wire cloth is then bent to form a cylinder 2A and the leading and trailing edges of walls of the wire cloth are crimped together 10 in a standard way. The bottom edge 12 includes segments of wire cloth that can be bent around the rim of bottom portion 50 to secure the bottom portion 50 to the side walls 2A. The cylinder 2A is then formed into a conical shape by a specially designed pleating tool. The resulting construction provides a strong and nestable design that is ideal for the intended application.

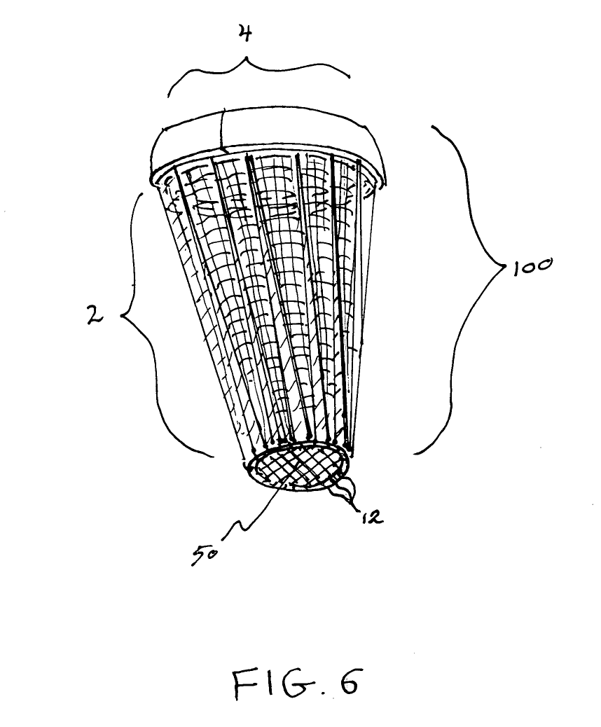

FIG. 6 shows a lower perspective view where the bottom portion 50 can be clearly seen as it is held in place by side wall segments 12.

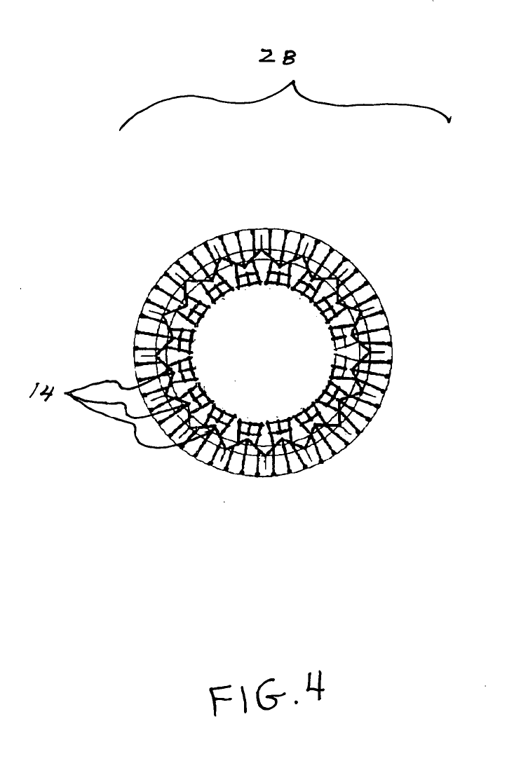

FIG. 2 shows that the cage 2 is tapered by creating pleats 6 in the wire cloth material. The pleats 6 are created by a fixture that pushes in 14 on the side walls as shown by the top plan view in FIG. 4. In this way, the cage side walls are formed 2B and are approximately ten inches in height with a top diameter of approximately seven and one half inches and a bottom diameter of approximately six inches. It should be noted that the above mentioned dimensions are the preferred embodiment, however other dimensions both larger and smaller can be made for larger or smaller plants.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1-9. (canceled)

10. What is claimed is:
a plant and root protector cage comprising:
a rectangular portion of wire cloth screen;
a bottom screen member;
an above ground collar;
said rectangular wire cloth screen rolled and formed into a pleated truncated conical shape;
the wide end of said conical shape being placed in an upward facing position and located near the surface of the soil that it is buried in;
said bottom screen member fixedly attached to fill the smaller, lower end of said truncated conical shape;
said above ground collar formed of two mating halves;
said halves each having a side wall and an attached top panel;
said top panel having a central plant receiving aperture;
said side walls of said collar having an upwardly disposed depression concentrically located on the bottommost surface of said collar;
said depression capable of removably receiving the said wide, upper end of said conical wire cloth screen.
